(19) United States
(12) Patent Application Publication
(10) Pub. No.: US 2025/0338368 A1
(43) Pub. Date: Oct. 30, 2025

(54) COOKING APPARATUS AND METHOD FOR CONTROLLING THE SAME

(71) Applicant: SAMSUNG ELECTRONICS CO., LTD., Suwon-si (KR)

(72) Inventor: Boram KWON, Suwon-si (KR)

(73) Assignee: SAMSUNG ELECTRONICS CO., LTD., Suwon-si (KR)

(21) Appl. No.: 19/197,021

(22) Filed: May 2, 2025

Related U.S. Application Data
(63) Continuation of application No. PCT/KR2025/004876, filed on Apr. 10, 2025.

(30) Foreign Application Priority Data
Apr. 25, 2024 (KR) 10-2024-0055725

(51) Int. Cl. H05B 6/68; G01J 5/00; G01J 5/08; G01J 5/48; H05B 6/64

(52) U.S. Cl. CPC H05B 6/688; G01J 5/0859; G01J 5/485; H05B 6/6455; G01J 2005/0077

(57) ABSTRACT

A cooking apparatus may include: a chamber in which food to be heated is placeable; a heating source configured to heat food placed in the chamber; an image sensor configured to obtain an image of food placed in the chamber; and a controller configured to: with food placed in the chamber, based on entering a defrost mode, operate the heating source for a preliminary defrost time to perform a preliminary defrost of the food, identify a surface area and a surface temperature distribution of the food from an image of the food after the preliminary defrost time, based on the identified surface area and surface temperature distribution, determine a volume of the food, perform a main defrost corresponding to the determined volume, and during the main defrost, adjust a power of the heating source based on the determined volume and a change in the identified surface temperature distribution.

### CROSS-REFERENCE TO RELATED APPLICATIONS

This is a continuation application, under 35 U.S.C. § 111(a), of International Application No. PCT/KR2025/004876, filed Apr. 10, 2025, which claims priority under 35 U.S.C. § 119 to Korean Patent Application No. 10-2024-0055725, filed Apr. 25, 2024, in the Korean Intellectual Property Office, the disclosures of which are incorporated herein in their entireties by reference.

### TECHNICAL FIELD

The disclosure relates to a cooking apparatus and a method for controlling the same.

### BACKGROUND ART

A cooking apparatus is a device for cooking by heating an object to be cooked such as food. The cooking apparatus may provide various functions related to cooking, including heating, defrosting, drying, and sterilizing the object to be cooked. For example, a cooking apparatus may refer to an oven such as a gas oven or an electric oven, a microwave heating device (hereinafter referred to as microwave), a gas stove, an electric stove, a gas grill, or an electric grill.

In general, an oven uses a heater generating heat to cook food by transferring heat directly to the food or by heating the inside of the cooking chamber. A microwave cooks food by frictional heat between molecules, which is produced by using high-frequency waves as a heat source to disturb molecular arrangement of the food.

A cooking apparatus provides a defrost mode for defrosting food. Existing cooking apparatuses are unable to automatically identify the weight and/or size of food and provide individual defrost algorithms corresponding to the weight and/or size of the food. Accordingly, existing cooking apparatuses perform incomplete defrosting of food, causing user inconvenience.

### DISCLOSURE

The disclosure provides a cooking apparatus and a method for controlling the same that may automatically identify a volume of food placed in a chamber and perform a defrost process corresponding to the volume of the food.

The disclosure provides a cooking apparatus and a method for controlling the same that may perform different defrost processes depending on a volume of food, and stepwise adjust a power level of a heating source according to changes in the temperature of the food.

In accordance with the present disclosure, a cooking apparatus may include: a chamber in which food to be heated is placeable; a heating source configured to heat the food placed in the chamber; an image sensor configured to obtain an image of the food placed in the chamber; and a controller configured to: with the food placed in the chamber, based on entering a defrost mode, operate the heating source for a preliminary defrost time to perform a preliminary defrost of the food, identify a surface area of the food and a surface temperature distribution of the food from an image of the food obtained by the image sensor after an elapse of the preliminary defrost time, based on the identified surface area and the identified surface temperature distribution, determine a volume of the food, perform a main defrost process corresponding to the determined volume, and adjust a power level of the heating source based on the determined volume and a change in the identified surface temperature distribution of the food during the main defrost process.

The controller may be further configured to: with the food placed in the chamber, set a preheating time to be shorter than the preliminary defrost time, and before the heating source is operated for the preliminary defrost time, operate the heating source at a maximum power level for the preheating time.

The controller may be further configured to: with the food placed in the chamber, based on the identified surface temperature distribution, determine at least one frozen region of the food where a temperature of the food in the surface area of the food is lower than a reference temperature, and based on a ratio of the determined at least one frozen region to the identified surface area, determine the volume of the food.

The controller may be further configured to: with the food placed in the chamber, based on the ratio of the determined at least one frozen region to the identified surface area being greater than a reference ratio, determine the volume of the food as a first volume, or based on the ratio of the determined at least one frozen region to the identified surface area being less than or equal to the reference ratio, determine the volume of the food as a second volume smaller than the first volume.

The main defrost process may include: a plurality of heating processes for operating the heating source to heat the food, and a plurality of stabilization processes for limiting an operation of the heating source to stabilize a temperature of the food, and the controller may be further configured to: during the main defrost process, alternately perform a heating process of the plurality of heating processes and a stabilization process of the plurality of stabilization processes a plurality of times.

The controller may be further configured to: during the main defrost process, perform the plurality of heating processes, and gradually reduce the power level of the heating source while the plurality of heating processes are performed.

The controller is further configured to: during the main defrost process, for each heating process of the plurality of heating processes, set a temperature condition based on the determined volume of the food, identify whether the set temperature condition is satisfied based on a surface temperature distribution of the food obtained by the image sensor while performing the heating process, and based on the temperature condition being identified as satisfied, stop the heating process and perform the stabilization process of the plurality of stabilization processes.

The controller may be further configured to: during the main defrost process, set a different temperature condition for each heating process of the plurality of heating processes based on the determined volume of the food.

The controller may be further configured to: during the main defrost process, perform the plurality of heating processes, for each heating process of the plurality of heating processes, set the power level to be different and the heating time to be different based on the determined volume of the food, and limit the operation of the heating source for a stabilization time which is set for each stabilization process of the plurality of stabilization processes after an elapse of the heating time.

The controller may be further configured to: with the food placed in the chamber, during the main defrost process, perform a first main defrost process corresponding to the determined first volume, or perform a second main defrost process corresponding to the determined second volume, and set the power level of the heating source to be different for the first main defrost process and the second main defrost process.

In accordance with the present disclosure, a method for controlling a cooking apparatus including a chamber in which food to be heated is placeable, a heating source configured to heat the food placed in the chamber, and an image sensor configured to obtain an image of the food placed in the chamber may include: with the food placed in the chamber, based on entering a defrost mode, operating a heating source for a preliminary defrost time to perform a preliminary defrost of the food, identifying a surface area of the food and a surface temperature distribution of the food from an image of the food obtained by the image sensor after an elapse of the preliminary defrost time, based on the identified surface area and the identified surface temperature distribution, determining a volume of the food, performing a main defrost process corresponding to the determined volume, and during the main defrost process, adjusting a power level of the heating source based on the determined volume and a change in the identified surface temperature distribution.

The method may further comprise: with the food placed in the chamber, setting a preheating time to be shorter than the preliminary defrost time, and before the heating source is operated for the preliminary defrost time, operating the heating source at a maximum power level for the preheating time.

The determining the volume may include: based on the identified surface temperature distribution, determining at least one frozen region of the food where a temperature of the food in the surface area of the food is lower than a reference temperature, and based on a ratio of the determined at least one frozen region to the identified surface area, determining the volume of the food.

The determining the volume may include: based on the ratio of the determined at least one frozen region to the identified surface area being greater than a reference ratio, determining the volume of the food as a first volume, or based on the ratio of the determined at least one frozen region to the identified surface area being less than or equal to the reference ratio, determining the volume of the food as a second volume smaller than the first volume.

The main defrost process may include: a plurality of heating processes for operating the heating source to heat the food, and a plurality of stabilization processes for limiting an operation of the heating source to stabilize a temperature of the food, and the performing the main defrost process may include alternately performing a heating process of the plurality of heating processes and a stabilization process of the plurality of stabilization processes a plurality of times.

According to the disclosure, a cooking apparatus and a method for controlling the same may automatically identify a volume of food placed in a chamber and perform a defrost process corresponding to the volume of the food. Accordingly, a user does not require to enter a weight or size of the food.

According to the disclosure, a cooking apparatus and a method for controlling the same may perform different defrost processes depending on a volume of food, and stepwise adjust a power level of a heating source according to changes in the temperature of the food.

According to the disclosure, a cooking apparatus and a method for controlling the same may automatically perform a defrost process corresponding to a volume of food without a user having to enter a weight or size of the food, thereby increasing defrost efficiency. In addition, a user does not require to pause the defrost process to turn over or reposition the food, or wait for a time to pause the defrost process.

The effects that may achieved by the disclosure are not limited to the above-mentioned effects, and other effects not mentioned will be clearly understood by one of ordinary skill in the technical art to which the disclosure belongs from the following description.

### DESCRIPTION OF DRAWINGS

FIG. 1 illustrates a network system implemented by various electronic devices.

FIG. 2 is a perspective view of a cooking apparatus according to an embodiment.

FIG. 3 is an exploded perspective view of a cooking apparatus according to an embodiment.

FIG. 4 is a control block diagram of a cooking apparatus according to an embodiment.

FIG. 5 illustrates an example of an image obtained by an image sensor.

FIG. 6 is a flowchart briefly illustrating a method for controlling a cooking apparatus according to an embodiment.

FIG. 7 is a flowchart illustrating in detail the method for determining the volume of food described in FIG. 6.

FIG. 8 is a flowchart illustrating a defrost process performed in a case where the volume of food is relatively large.

FIG. 9 is a flowchart illustrating a defrost process performed in a case where the volume of food is relatively small.

### MODES OF THE DISCLOSURE

Various embodiments of the disclosure and terms used herein are not intended to limit the technical features described herein to specific embodiments, and should be understood to include various modifications, equivalents, or substitutions of the corresponding embodiments.

In describing of the drawings, similar reference numerals may be used for similar or related elements.

The singular form of a noun corresponding to an item may include one or more of the items unless clearly indicated otherwise in a related context.

In the disclosure, phrases, such as “A or B”, “at least one of A and B”, “at least one of A or B”, “A, B or C”, “A, B, or C”, “at least one of A, B and C”, “at least one of A, B, and C”, “at least one of A, B or C”, and “at least one of A, B, or C” may include any one or all possible combinations of the items listed together in the corresponding phrase among the phrases.

Terms such as “1st”, “2nd”, “primary”, or “secondary” may be used simply to distinguish an element from other elements, without limiting the element in other aspects (e.g., importance or order).

When an element (e.g., a first element) is referred to as being “(functionally or communicatively) coupled” or “connected” to another element (e.g., a second element), the first element may be connected to the second element, directly (e.g., wired), wirelessly, or through a third element.

It will be understood that when the terms “includes”, “comprises”, “including”, and/or “comprising” are used in the disclosure, they specify the presence of the specified features, figures, steps, operations, components, members, or combinations thereof, but do not preclude the presence or addition of one or more other features, figures, steps, operations, components, members, or combinations thereof.

When a given element is referred to as being “connected to”, “coupled to”, “supported by” or “in contact with” another element, it is to be understood that it may be directly or indirectly connected to, coupled to, supported by, or in contact with the other element. When a given element is indirectly connected to, coupled to, supported by, or in contact with another element, it is to be understood that it may be connected to, coupled to, supported by, or in contact with the other element through a third element.

It will also be understood that when an element is referred to as being “on” another element, it may be directly on the other element or intervening elements may also be present.

As used herein, the term “and/or” includes any and all combinations of one or more of the associated listed items.

Hereinafter, the principles of operation and embodiments of the disclosure will be described with reference to the accompanying drawings.

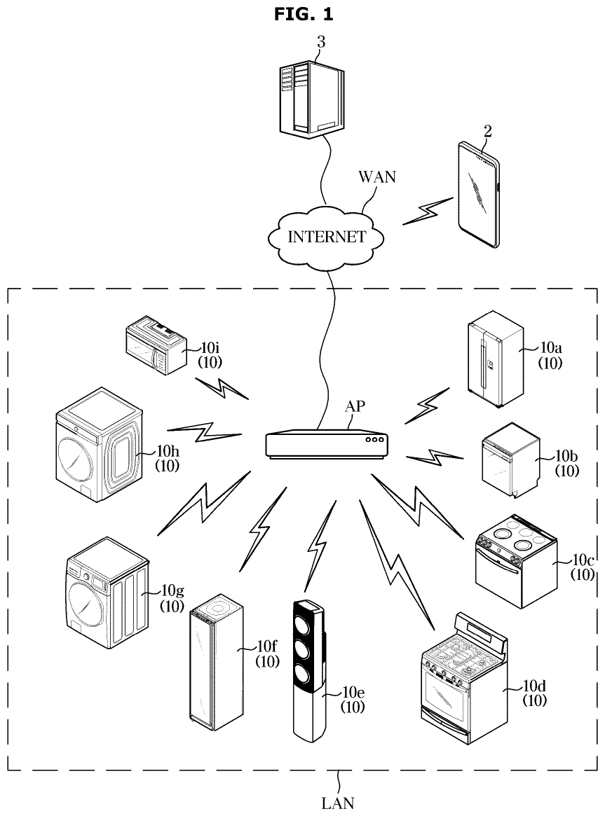

FIG. 1 illustrates a network system implemented by various electronic devices.

Referring to FIG. 1, a home appliance 10 may include a communication module capable of communicating with another home appliance, a user device 2, or a server 3, a user interface that receives a user input or outputs information to a user, at least one processor that controls an operation of the home appliance 10, and at least one memory that stores a program for controlling the operation of the home appliance 10.

The home appliance 10 may be at least one of various types of home appliances. For example, as shown in the accompanying drawings, the home appliance 10 may include at least one of a refrigerator 10a, a dishwasher 10b, an electric range 10c, an electric oven 10d, an air conditioner 10e, a clothes treating apparatus 10f, a washing machine 10g, a dryer 10h, or a microwave oven 10i. The microwave oven 10i may be a microwave.

The home appliance 10 is not limited the above examples. For example, the home appliance 10 may include various types of appliances not shown in the drawings, such as a cleaning robot, a vacuum cleaner, a television, and the like. Furthermore, the aforementioned home appliances are by way of example only, and in addition to the aforementioned home appliances, other appliances connected to other home appliance, the user device 2, or the server 3 to perform operations described below may be included in the home appliance 10 according to an embodiment.

The server 3 may include a communication module communicating with another server, the home appliance 10, or the user device 2, at least one processor that processes data received from another server, the home appliance 10, or the user device 2, and at least one memory that stores programs for processing data or processed data. The server 3 may be implemented as a variety of computing devices, such as a workstation, a cloud, a data drive, a data station, and the like. The server 3 may be implemented as one or more server physically or logically separated based on a function, detailed configuration of function, or data, and may transmit and receive data through communication between servers and process the transmitted and received data.

The server 3 may perform functions, such as managing a user account, registering the home appliance 10 in association with the user account, managing or controlling the registered home appliance 10, and the like. For example, a user may access the server 3 via the user device 2 and may create a user account. The user account may be identified by an identifier (ID) and a password set by the user. The server 3 may register the home appliance 10 with the user account according to a predetermined procedure. For example, the server 3 may link identification information of the home appliance 10 (e.g., a serial number or MAC address) to the user account to register, manage, and control the home appliance 10. The user device 2 may include a communication module capable of communicating with the home appliance 10 or the server 3, a user interface that receives a user input or outputs information to a user, at least one processor that controls an operation of the user device 2, and at least one memory that stores a program for controlling the operation of the user device 2.

The user device 2 may be carried by a user, or placed in a user's home or office, or the like. The user device 2 may include a personal computer (PC), a terminal, a portable telephone, a smartphone, a handheld device, a wearable device, and the like, but is not limited thereto.

The memory of the user device 2 may store a program for controlling the home appliance 10, i.e., an application. The application may be sold installed on the user device 2, or may be downloaded from an external server for installation.

By running the application installed on the user device 2 by a user, the user may access the server 3, create a user account, and communicate with the server 3 based on the login user account to register the home appliance 10.

For example, by operating the home appliance 10 to allow the home appliance 10 to access the server 3 according to a procedure guided by the application installed on the user device 2, the server 3 may register the home appliance 10 with the user account by assigning the identification information (e.g., a serial number or a MAC address) of the home appliance 10 to the corresponding user account.

A user may control the home appliance 10 using the application installed on the user device 2. For example, by logging into a user account with the application installed on the user device 2, the home appliance 10 registered in the user account appears, and by inputting a control command for the home appliance 10, the control command may be delivered to the home appliance 10 via the server 3.

A network may include both a wired network and a wireless network. The wired network may include a cable network or a telephone network, and the wireless network may include any networks transmitting and receiving a signal via radio waves. The wired network and the wireless network may be interconnected.

The network may include a wide area network (WAN), such as the Internet, a local area network (LAN) formed around an access point (AP), and a short-range wireless network that does not use an AP. The short-range wireless network may include Bluetooth™ (IEEE 802.15.1), Zigbee (IEEE 802.15.4), Wi-Fi Direct, near field communication (NFC), and Z-Wave, but is not limited thereto.

The AP may connect the home appliance 10 or the user device 2 to a WAN connected to the server 3. The home appliance 10 or the user device 2 may be connected to the server 3 via a WAN.

The AP may communicate with the home appliance 10 or the user device 2 using wireless communication, such as Wi-Fi (IEEE 802.11), Bluetooth™ (IEEE 802.15.1), Zigbee (IEEE 802.15.4), and the like, and access a WAN using wired communication, but is not limited thereto.

According to various embodiments, the home appliance 10 may be directly connected to the user device 2 or the server 3 without going through an AP.

The home appliance 10 may be connected to the user device 2 or the server 3 via a long-range wireless network or a short-range wireless network.

For example, the home appliance 10 may be connected to the user device 2 via a short-range wireless network (e.g., Wi-Fi Direct).

In another example, the home appliance 10 may be connected to the user device 2 or the server 3 via a WAN using a long-range wireless network (e.g., a cellular communication module).

In still another example, the home appliance 10 may access a WAN using wired communication, and may be connected to another home appliance 10 or the server 3 via a WAN.

When accessing a WAN using wired communication, the home appliance 10 may also act as an AP. Accordingly, the home appliance 10 may connect another home appliance 10 to a WAN to which the server 3 is connected. In addition, another home appliance 10 may connect the home appliance 10 to the WAN to which the server 3 is connected.

The home appliance 10 may transmit information about an operation or state to other home appliances, the user device 2, or the server 3 via the network. For example, the home appliance 10 may transmit information about an operation or state to other home appliances, the user device 2, or the server 3 upon receiving a request from the server 3, in response to an event in the home appliance 10, or periodically or in real time. Upon receiving the information about the operation or state from the home appliance 10, the server 3 may update the stored information about the operation or state of the home appliance 10 and transmit the updated information about the operation and state of the home appliance 10 to the user device 2 via the network. Here, updating the information may include various operations in which existing information is changed, such as adding new information to the existing information, replacing the existing information with new information, and the like.

The home appliance 10 may obtain various information from other home appliances, the user device 2, or the server 3, and may provide the obtained information to a user. For example, the home appliance 10 may obtain information related to a function of the home appliance 10 (e.g., recipes, washing instructions, etc.) from the server 3 and various environmental information (e.g., weather, temperature, humidity, etc.), and may output the obtained information via a user interface.

The home appliance 10 may operate in accordance with a control command received from other home appliances, the user device 2, or the server 3. For example, the home appliance 10 may operate in accordance with a control command received from the server 3, based on a prior authorization obtained from a user to operate in accordance with the control command of the server 3 even without a user input. Here, the control command received from the server 3 may include a control command input by the user via the user device 2 or a control command based on preset conditions, but is not limited thereto.

The user device 2 may transmit information about a user to the home appliance 10 or the server 3 via the communication module. For example, the user device 2 may transmit information about a user's location, a user's health condition (i.e., state), a user's preference, a user's schedule, and the like to the server 3. The user device 2 may transmit information about the user to the server 3 based on the user's prior authorization.

The home appliance 10, the user device 2, or the server 3 may use techniques, such as artificial intelligence (AI) to determine a control command. For example, the server 3 may receive information about an operation or a state of the home appliance 10 or information about a user of the user device 2, process the received information using techniques, such as AI, and transmit a processing result or a control command to the home appliance 10 or the user device 2 based on the processing result.

A cooking apparatus 1 described below corresponds to the home appliance 10 described above.

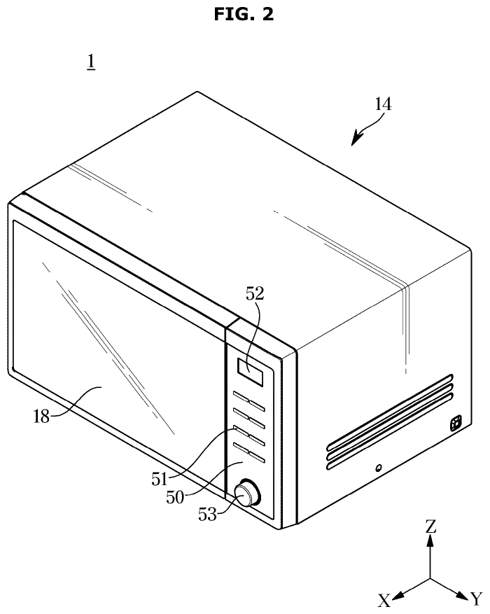

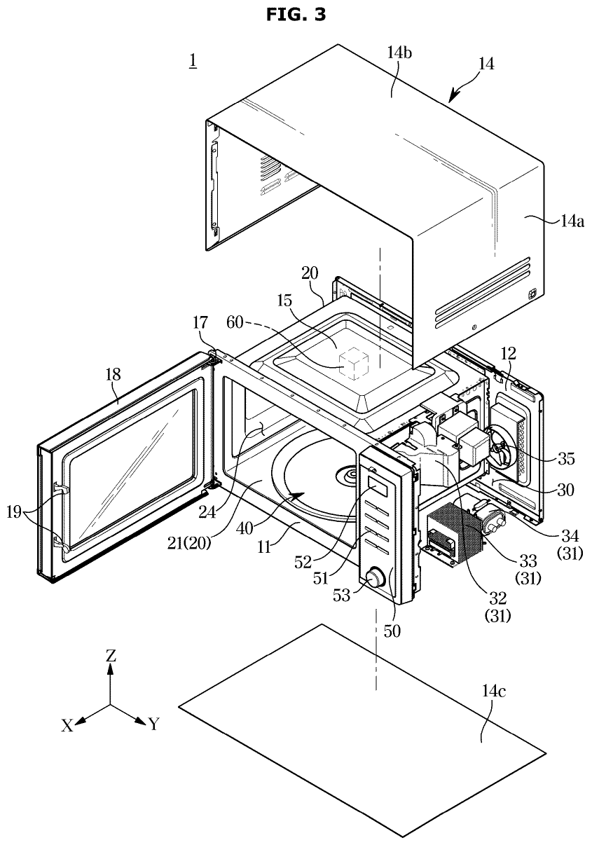

FIG. 2 is a perspective view of a cooking apparatus according to an embodiment. FIG. 3 is an exploded perspective view of a cooking apparatus according to an embodiment.

Referring to FIG. 2 and FIG. 3, the cooking apparatus 1 may include a case 14 forming an exterior. The case 14 may include a first cover 14a covering a side (Y direction) of the cooking apparatus 1, a second cover 14b covering an upper side (+Z direction) of the cooking apparatus 1, and a third cover 14c covering a lower side (−Z direction) of the cooking apparatus 1.

In addition, the cooking apparatus 1 may include a front panel 11, a rear panel 12, and a top panel 15, which may be coupled with at least a portion of the case 14.

The first cover 14a, the second cover 14b, and the third cover 14c may be arranged between the front panel 11 and the rear panel 12. The first cover 14a and the second cover 14b may be integrally formed and may be coupled with the third cover 14c. Alternatively, the first cover 14a and the second cover 14b may be separate covers that may be coupled with each other.

The cooking apparatus 1 may include a housing 20 forming a chamber 24. The chamber 24 may be formed inside the housing 20, and food may be placed in the chamber 24. Food may refer to an object to be cooked by the cooking apparatus 1. The housing 20 may be covered by the case 14. The front panel 11 and the rear panel 12 may be coupled with the housing 20. The top panel 15 may be formed integrally with the housing 20 or be coupled with the housing 20.

The cooking apparatus 1 may include a door 18 coupled to the front panel 11 to open or close the chamber 24. The door 18 may be rotatably coupled to the front panel 11. At least a portion of the door 18 may be formed of a transparent material (e.g., transparent glass) or a translucent material (e.g., translucent glass). The door 18 may include heat-resistant glass. A user may see the interior of the chamber 24 through the door 18.

An electronic equipment chamber 30 may be formed between the case 14 and the housing 20. Various electronic components may be disposed inside the electronic equipment chamber 30. For example, the cooking apparatus 1 may include a heating source 31 and a fan 35, both of which are disposed in the electronic equipment chamber 30.

The heating source 31 corresponds to a device for heating food placed in the chamber 24. For example, the heating source 31 may provide at least one of microwaves or heat to the interior of the chamber 24.

The fan 35 may supply air into the electronic equipment chamber 30 or discharge air from the electronic equipment chamber 30 to the outside. Various electronic components disposed in the electronic equipment chamber 30 may be cooled by operation of the fan 35.

The heating source 31 may include a magnetron 32 for emitting microwaves into the chamber 24, and a transformer 33 and a condenser 34 for applying voltage to the magnetron 32. The magnetron 32, the transformer 33, and the condenser 34 may be located in the electronic equipment chamber 30.

Microwaves emitted into the chamber 24 by the magnetron 32 may change the molecular arrangement of moisture contained in the food. When the molecular arrangement of moisture is repeatedly changed, frictional heat may be generated between the molecules, and the food may be heated by the frictional heat.

The heating source 31 may also include a heater for supplying heat to the chamber 24. One or more heaters may be provided. When power is supplied to the heater, a heating wire forming the heater may generate radiant heat. Food may be heated by the radiant heat generated by the heater.

The cooking apparatus 1 may include a turntable 40 disposed inside the chamber 24. Food may be placed on an upper surface of the turntable 40. The turntable 40 may be rotated by a motor. The turntable 40 may be supported by a bottom side 21 of the housing 20.

The cooking apparatus 1 may include a user interface 50 for displaying information related to operation of the cooking apparatus 1 and for receiving user input. The user interface 50 may be coupled to the front panel 11. The user interface 50 may be located on one side of the door 18. The user interface 50 may be positioned on a side of the front panel 11 opposite a hinge 17 that rotatably supports the door 18.

The user interface 50 may include at least one of an input portion 51 for receiving user input, a display 52 for displaying information related to operation of the cooking apparatus 1, or a door-open button 53 for opening the door 18. The positions of the input portion 51, the display 52, and the door-open button 53 are merely examples and are not limited to the positions shown.

The input portion 51 may transmit an electrical signal (voltage or current) corresponding to a user input to a controller 200. The input portion 51 may include various buttons and/or dials. For example, the input portion 51 may include at least one of a power button for turning on or off the cooking apparatus 1, a start/stop button for starting or stopping a cooking operation, a cooking mode button for selecting a cooking mode, a temperature button for setting a cooking temperature, or a time button for setting a cooking time. Various buttons may be provided as physical buttons or touch buttons.

One of a plurality of cooking modes may be selected via the input portion 51. For example, the cooking apparatus 1 may provide various cooking modes, such as an automatic cooking mode, a defrost mode, and a heating mode. The cooking apparatus 1 may perform cooking according to the selected cooking mode. A cooking mode may include cooking parameters, such as a cooking temperature, cooking time, and/or output of the heating source 31. A different cooking mode may be selected depending on the type, quantity, and/or size of the food.

A power level of the heating source 31 may be adjusted by the controller 200. The output of the heating source 31 may be adjusted differently depending on the type, quantity, and/or size of the food. In other words, operation of the heating source 31 may be controlled differently depending on the cooking mode.

The display 52 may be provided as various types of display panels. For example, the display 52 may include a liquid crystal display panel (LCD) panel, a light emitting diode (LED) panel, an organic light emitting diode (OLED) panel, or a micro-LED panel. The display 52 may serve as an input device by including a touch screen.

The cooking apparatus 1 may include an image sensor 60 for obtaining an image of the interior of the chamber 24. The image sensor 60 may obtain an image of the interior of the chamber 24. The image sensor 60 may have a predetermined field of view (FOV). The image sensor 60 may be located at an upper portion of the chamber 24, and may have a FOV directed from the top of the chamber 24 toward the interior of the chamber 24. The image sensor 60 may transmit data of the obtained image to the controller 200.

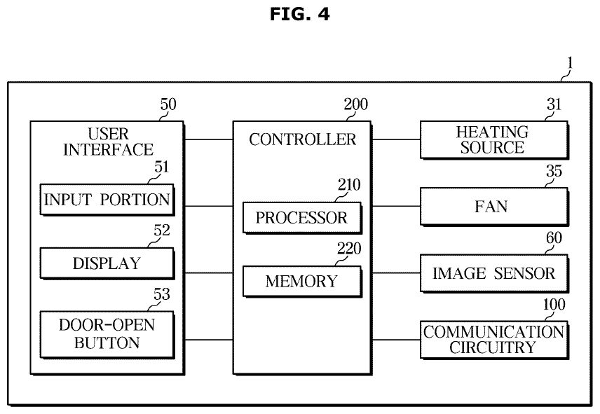

FIG. 4 is a control block diagram of a cooking apparatus according to an embodiment.

Referring to FIG. 4, the cooking apparatus 1 may include the heating source 31, the fan 35, the user interface 50, the image sensor 60, communication circuitry 100, and the controller 200. The controller 200 may be electrically connected to components of the cooking apparatus 1 and may control the components.

The heating source 31 may include at least one of the magnetron 32 emitting microwaves into the chamber 24, or a heater supplying heat into the chamber 24. The controller 200 may adjust a power level of the heating source 31. The power level of the heating source 31 may be adjusted based on a user input obtained through the input portion 51 or the user device 2. The power level of the heating source 31 may be adjusted based on a cooking mode.

In a case where the heating source 31 corresponds to the magnetron 32, the power level of the heating source 31 may refer to a ratio of a driving time of the magnetron 32 to a predetermined unit time. In other words, the power level of the heating source 31 may represent an on-off duty ratio of the magnetron 32 during the unit time. The unit time may vary depending on the design. For example, in a case where the power level of the heating source 31 is 100%, the magnetron 32 may continuously generate microwaves during the unit time. In a case where the power level of the heating source 31 is 40%, the magnetron 32 may generate microwaves for 40% of the unit time (on-time), and not generate microwaves for the remaining 60% of the unit time (off-time).

In a case where the heating source 31 corresponds to a heater, the power level of the heater may represent a ratio of a driving temperature to a maximum temperature of radiant heat generated by the heater. As a power level of the heater is set higher, a temperature of radiant heat supplied into the chamber 24 by the heater may be increased.

The fan 35 may supply air into the electronic equipment chamber 30 or discharge air from the electronic equipment chamber 30 to the outside. The controller 200 may adjust a rotation speed of the fan 35. For example, the rotation speed of the fan 35 may be adjusted to be directly proportional to the power level of the heating source 31.

The user interface 50 may include the input portion 51, the display 52, and the door-open button 53, but is not limited thereto. The user interface 50 may include various components depending on the design.

The input portion 51 may obtain a user input including various commands. For example, the input portion 51 may obtain at least one of a command to select an item, a command to select a cooking mode, a command to adjust a power level of the heating source 31, a command to adjust a cooking time, a command to adjust a cooking temperature, a command to start cooking, or a command to stop cooking. User input may be obtained from the user device 2.

The controller 200 may process the command received via the input portion 51 or the user device 2 to control operation of the cooking apparatus 1. The cooking apparatus 1 may automatically perform cooking based on cooking mode information obtained from the memory 220, the user device 2, or the server 3.

The display 52 may display information related to the operation of the cooking apparatus 1. The display 52 may display information input by a user or provided to a user in various screens. The display 52 may display information related to the operation of the cooking apparatus 1 as at least one of image or text. The display 52 may also display a graphic user interface (GUI) that enables control of the cooking apparatus 1. That is, the display 52 may display user interface elements (UI elements) such as icons.

The image sensor 60 may obtain an image of the interior of the chamber 24. The image sensor 60 may have a predetermined field of view (FOV). The image sensor 60 may be located at an upper portion of the chamber 24 and may have an FOV directed from the top of the chamber 24 toward the interior of the chamber 24. After the cooking apparatus 1 is turned on and the door 18 is closed, the controller 200 may control the image sensor 60 to obtain an image of the interior of the chamber 24. The controller 200 may control the image sensor 60 to obtain images of the interior of the chamber 24 at predetermined time intervals from beginning to the end of cooking.

The image sensor 60 may include various cameras. For example, the image sensor 60 may correspond to a thermal imaging camera that obtains thermal images, such as an infrared camera. In addition, the image sensor 60 may include a visible light camera.

The communication circuitry 100 may perform communication with at least one of the user device 2 or the server 3 via a network. Through the communication circuitry 100, the controller 200 may obtain various information, signals, and/or data from the server 3. For example, the communication circuitry 100 may receive a remote control signal from the user device 2. The controller 200 may acquire an artificial intelligence (AI) model used to analyze images obtained by the image sensor 60 from the server 3 through the communication circuitry 100.

The communication circuitry 100 may include various communication modules. The communication circuitry 100 may include a wireless communication module and/or a wired communication module. As wireless communication technologies, a wireless local area network (WLAN), home radio frequency (Home RF), infrared communication, ultra-wide band (UWB) communication, Wi-Fi, Bluetooth™, and Zigbee may be used.

The controller 200 may include a processor 210 and memory 220. The processor 210 may include logic circuits and operation circuits in hardware. The processor 210 may control electrically connected components of the cooking apparatus 1, by using programs, instructions, and/or data stored in the memory 220 for operation of the cooking apparatus 1. The controller 200 may be implemented with a control circuit including circuit elements such as a condenser, an inductor, and a resistor. The processor 210 and the memory 220 may be implemented in separate chips or in a single chip. Furthermore, the controller 200 may include a plurality of processors and a plurality of memories.

The memory 220 may store the programs, applications, and/or data for the operation of the cooking apparatus 1, and may store data generated by the processor 210. The memory 220 may include a non-volatile memory such as a read only memory (ROM) or flash memory for long-term data storage. The memory 220 may include a volatile memory such as static random access memory (S-RAM) or dynamic random access memory (D-RAM) for temporary data storage.

The components of the cooking apparatus 1 are not limited to the above-described components. The cooking apparatus 1 may further include various components in addition to the aforementioned components, and some of the aforementioned components may be omitted.

For example, the cooking apparatus 1 may include a temperature sensor for detecting a temperature inside the chamber 24. The temperature sensor may be installed at various positions in the chamber 24, and may transmit an electrical signal corresponding to the detected temperature to the controller 200. The controller 200 may control the heating source 31 to allow the temperature inside the chamber 24 to be maintained at a cooking temperature determined according to the type, quantity, and/or cooking mode of the food. In addition, the cooking apparatus 1 may include a current sensor and a voltage sensor. The current sensor may measure current applied to electronic components of the cooking apparatus 1, and the voltage sensor may measure voltage applied to electronic components of the cooking apparatus 1.

The controller 200 may process the image obtained by the image sensor 60 to identify an object included in the image. The controller 200 may use an AI model acquired from the memory 220 or the server 3 to identify food in the image and estimate characteristics of the food. The characteristics of the food may include the type of food, the quantity of food, the surface area of the food, the volume of the food, and/or the size of the food.

In addition, the controller 200 may identify a surface temperature distribution of the food from the image (e.g., a thermal image) obtained by the image sensor 60. Based on the surface temperature distribution of the food, the controller 200 may divide a surface of the food into a plurality of regions. The controller 200 may identify a temperature of each of the plurality of regions. In addition, based on the surface temperature distribution of the food, the controller 200 may determine at least one frozen region that represents a temperature lower than a reference temperature (e.g., 0° C.).

While the food is heated, the surface temperature distribution of the food may continuously change. For example, a thickness of frozen food may not be uniform across the entire surface area. In a case where the entire food is heated for a certain period of time, a thicker portion of the food shows a slower temperature change. Accordingly, different temperatures may be detected at different parts of the surface of the food. In a case where a central part of food is thicker than a peripheral part, the temperature of the peripheral part of the food surface may appear relatively higher, and the temperature of the central part may appear relatively lower.

The AI model may be created by machine learning and/or deep learning. The AI model may be created by the server 3 and stored in the memory 220 of the cooking apparatus 1. A learning algorithm may include, for example, supervised learning, unsupervised learning, semi-supervised learning, or reinforcement learning, but is not limited to thereto.

The AI model may include a plurality of artificial neural network layers. The artificial neural network may include deep neural network (DNN), convolutional neural network (CNN), recurrent neural network (RNN), restricted Boltzmann machine (RBM), deep belief network (DBN), bidirectional recurrent deep neural network (BRDNN), and/or deep Q-network, but is not limited to thereto. Additionally or alternatively, the AI model may include a software structure in addition to the hardware structure.

Based on a surface temperature of the food, the controller 200 may determine whether to enter an automatic cooking mode or a defrost mode. For example, in a case where the lowest temperature among temperatures of the plurality of regions of the food is higher than 0° C., the controller 200 may determine to enter the automatic cooking mode. In a case where the highest temperature among temperatures of the plurality of regions of the food is lower than 0° C., the controller 200 may determine to enter the defrost mode.

When a command to start a cooking operation is input via the input portion 51, the controller 200 may determine whether to enter the automatic cooking mode or the defrost mode. For example, the command to start a cooking operation may be input through the start/stop button or one of various cooking mode buttons.

The defrost mode provided by the cooking apparatus 1 according to the disclosure may include a preliminary defrost process and a main defrost process, and may include a preheating process for the food prior to the preliminary defrost process.

Based on entry into the defrost mode, the controller 200 may perform a preliminary defrost on the food. To perform the preliminary defrost, the controller 200 may operate the heating source 31 for a preliminary defrost time (e.g., 50 seconds). To perform the preliminary defrost, the controller 200 may set a power level of the heating source 31 to a reference level (e.g., 40%).

The controller 200 may determine a volume of the food based on a ratio of at least one frozen region to the surface area of the food. For example, the controller 200 may determine the volume of the food to be a first volume, based on the ratio of the at least one frozen region to the surface area of the food being greater than a reference ratio (e.g., 40%). The controller 200 may determine the volume of the food to be a second volume smaller than the first volume, based on the ratio of the at least one frozen region to the surface area of the food being less than or equal to the reference ratio (e.g., 40%). The controller 200 may determine the volume of the food after performing the preliminary defrost.

The controller 200 may also preheat the food before performing the preliminary defrost. In other words, the controller 200 may operate the heating source 31 at a maximum power level (e.g., 100%) for a preheating time (e.g., 10 seconds) to preheat the food before performing the preliminary defrost. The preheating time may be set shorter than the preliminary defrost time. After operating the heating source 31 for the preheating time (e.g., 10 seconds), the controller 200 may stop operation of the heating source 31 for a standby time (e.g., 50 seconds). During the standby time, molecules of the food heated for the preheating time may transfer heat to each other. By setting a standby time, temperature differences in the plurality of regions of the food may be reduced, and the temperature of the food may be stabilized.

After the volume of the food is determined, the controller 200 may perform the main defrost process corresponding to the volume of the food. The main defrost process may include a plurality of heating processes for operating the heating source 31 to heat the food, and a plurality of stabilization processes for limiting operation of the heating source 31 to stabilize the temperature of the food.

During the main defrost process, the controller 200 may alternately perform the heating process and stabilization process multiple times. While sequentially performing the plurality of heating processes, the controller 200 may gradually reduce the power level of the heating source 31.

The controller 200 may set a different power level of the heating source 31 for each of the plurality of heating processes based on the volume of the food. The controller 200 may also set a different heating time for each of the plurality of heating processes based on the volume of the food. After the heating time elapses, the controller 200 may limit operation of the heating source 31 for a stabilization time set for each of the plurality of stabilization processes. The controller 200 may set a different stabilization time for each of the plurality of stabilization processes.

The molecules of the heated food may transfer heat to each other during a stabilization time. By setting a stabilization time, temperature differences in the plurality of regions of the food may be reduced, and the temperature of the food may be stabilized.

The controller 200 may set a temperature condition for each of the plurality of heating processes based on the volume of the food. The controller 200 may set a different temperature condition for each of the plurality of heating processes based on the volume of the food. The controller 200 may identify whether each temperature condition is satisfied based on the surface temperature distribution of the food, while performing each of the plurality of heating processes. The controller 200 may stop the heating process based on the temperature condition being satisfied, and may perform the stabilization process.

The controller 200 may perform a first main defrost process corresponding to the first volume of food, based on determining that the volume of the food is the first volume. The controller 200 may perform a second main defrost process corresponding to the second volume smaller than the first volume, based on determining that the volume of the food is the second volume. The controller 200 may adjust the power level of the heating source 31 differently for the first main defrost process and the second main defrost process.

The first main defrost process may include a plurality of first heating processes and a plurality of first stabilization processes. The second main defrost process may include a plurality of second heating processes and a plurality of second stabilization processes. The number of first heating processes may be greater than the number of second heating processes, and the number of first stabilization processes may also be greater than the number of second stabilization processes.

Although it has been described that the operation of the cooking apparatus 1 is controlled by the controller 200, the disclosure is not limited. Operation of the cooking apparatus 1 may also be described as being controlled by the processor 210. The processor 210 may execute various instructions stored in the memory 220 to enable the cooking apparatus 1 to perform various operations.

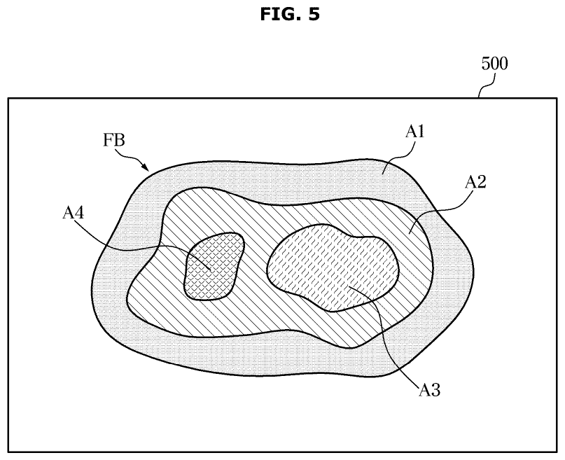

FIG. 5 illustrates an example of an image obtained by an image sensor.

Referring to FIG. 5, an image 500 obtained by the image sensor 60 corresponds to a thermal image. The controller 200 may process the image 500 to identify the food and characteristics of the food. For example, the controller 200 may identify a contour FB of the food and a surface area of the food, and may also identify a surface temperature distribution of the food.

The cooking apparatus 1 may divide a surface of the food into a plurality of regions based on the surface temperature distribution of the food. In FIG. 5, an example in which the surface of the food is divided into a first region A1, a second region A2, a third region A3, and a fourth region A4 according to the surface temperature distribution is shown. When the food is heated, the regions A1 through A4 may each have a different temperature. In other words, a first temperature in the first region A1, a second temperature in the second region A2, a third temperature in the third region A3, and a fourth temperature in the fourth region A4 may appear differently.

For example, the first region A1 may have the highest temperature, and the fourth region A4 may have the lowest temperature. The second temperature of the second region A2 may be lower than the first temperature of the first region A1 and higher than the third temperature of the third region A3. The third temperature of the third region A3 may be lower than the second temperature of the second region A2 and higher than the fourth temperature of the fourth region A4. In addition, the first temperature of the first region A1 may be higher than 0° C., while the second temperature of the second region A2, the third temperature of the third region A3, and the fourth temperature of the fourth region A4 may be lower than 0° C.

Based on the above, the cooking apparatus 1 may estimate the volume of the food. The volume of the food may be estimated from the surface area of the food and the thickness of the food. Based on the surface temperature distribution of the food, the cooking apparatus 1 may estimate thicknesses of the plurality of regions of the food. In a case where the entire food is heated for a certain period of time, a thicker portion of the food shows a slower temperature change. Accordingly, the cooking apparatus 1 may estimate a first thickness for the first region A1, a second thickness for the second region A2, a third thickness for the third region A3, and a fourth thickness for the fourth region A4 in relative terms. For example, the cooking apparatus 1 may determine that the first region A1 has the smallest thickness and the fourth region A4 has the largest thickness as well. The cooking apparatus 1 may determine that the second region A2 has a thickness greater than the first thickness and less than the third thickness. The cooking apparatus 1 may determine that the third region A3 has a thickness greater than the second thickness and less than the fourth thickness.

The cooking apparatus 1 may determine the volume of the food as a first volume (large volume) or a second volume (small volume), based on a ratio of at least one frozen region to the surface area of the food. In a case where the ratio of at least one frozen region to the surface area of the food is greater than a reference ratio (e.g., 40%), the volume of the food may be determined as the first volume (large volume). In a case where the ratio of at least one frozen region to the surface area of the food is less than or equal to the reference ratio, the volume of the food may be determined as the second volume (small volume).

In FIG. 5, the second region A2, the third region A3, and the fourth region A4 may correspond to frozen regions. Because the ratio of the frozen region to the surface area of the food is greater than the reference ratio, the cooking apparatus 1 may determine the volume of the food to be the first volume (large volume). Thereafter, the cooking apparatus 1 may perform the first main defrost process corresponding to the first volume (large volume) of the food.

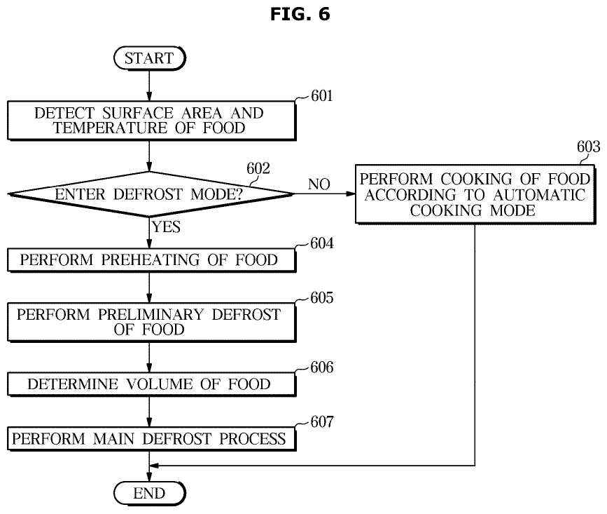

FIG. 6 is a flowchart briefly illustrating a method for controlling a cooking apparatus according to an embodiment.

Referring to FIG. 6, the controller 200 of the cooking apparatus 1 may process an image (e.g., a thermal image) obtained by the image sensor 60 to detect a surface area and a temperature of the food (601). The temperature of the food may refer to a surface temperature of the food. In addition, the controller 200 may detect a surface temperature distribution of the food.

The controller 200 of the cooking apparatus 1 may determine whether to enter a defrost mode based on the temperature of the food (602). For example, in a case where the surface temperature of the food is lower than 0° C., the controller 200 may determine to enter the defrost mode. In a case where the food is divided into a plurality of regions based on the surface temperature distribution and the highest temperature of the temperature of each of the plurality of regions is lower than 0° C., the controller 200 may determine to enter the defrost mode. In a case where a condition for entering the defrost mode is not satisfied, the controller 200 may determine to enter an automatic cooking mode and may perform cooking of the food according to the automatic cooking mode (603).

Based on entry into the defrost mode, the controller 200 of the cooking apparatus 1 may perform preheating of the food (604). The controller 200 may operate the heating source 31 at a maximum power level (e.g., 100%) for a predetermined preheating time (e.g., 10 seconds) to preheat the food. After the preheating time, the controller 200 may stop operation of the heating source 31 for a standby time (e.g., 50 seconds).

Even the same food may have different temperatures depending on its storage condition. For example, in the case of extremely low-temperature frozen food, each region may be determined as a frozen region even after a preliminary defrost, resulting in an inaccurate determination of the volume of the food. To overcome the above, the cooking apparatus 1 may preheat the food before performing the preliminary defrost. By performing the preheating process before the preliminary defrost, the cooking apparatus 1 may increase accuracy in estimating the volume of the food. The preheating process may be omitted depending on the surface temperature of the food. In other words, by first increasing the surface temperature of the food during the preheating process, the surface temperature distribution of the food may become more varied during the preliminary defrost. Accordingly, the volume of the food may be estimated more accurately after the preliminary defrost.

Thereafter, the controller 200 of the cooking apparatus 1 may perform the preliminary defrost on the food (605). To perform the preliminary defrost on the food, the controller 200 may operate the heating source 31 for a preliminary defrost time (e.g., 50 seconds). To perform the preliminary defrost on the food, the controller 200 may set a power level of the heating source 31 as a reference power level (e.g., 40%).

After completion of the preliminary defrost, the cooking apparatus 1 may determine the volume of the food (606). Once the volume of the food is determined, the controller 200 of the cooking apparatus 1 may perform a main defrost process corresponding to the volume of the food (607). The main defrost process may include a plurality of heating processes for operating the heating source 31 to heat the food and a plurality of stabilization processes for limiting operation of the heating source 31 to stabilize the temperature of the food. The controller 200 may alternately perform the heating process and the stabilization process a plurality of times during the main defrost process. The controller 200 may gradually reduce the power level of the heating source 31, while performing the plurality of heating processes sequentially.

After the main defrost process of the food is completed, the cooking apparatus 1 may end operation.

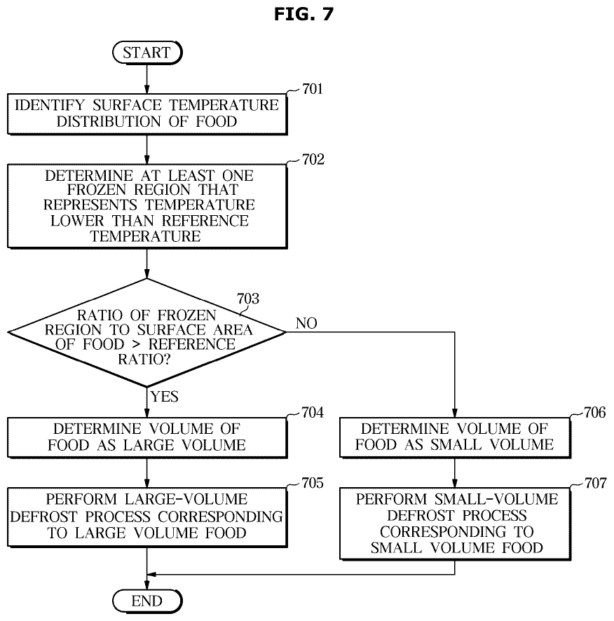

FIG. 7 is a flowchart illustrating in detail the method for determining the volume of food (606) described in FIG. 6.

Referring to FIG. 7, after the preliminary defrost time elapses, the controller 200 of the cooking apparatus 1 may identify the surface temperature distribution of the food from an image obtained by the image sensor 60 (701). Identifying the surface temperature distribution of the food may include identifying the surface area of the food. In other words, after performing the preliminary defrost (605) described in FIG. 6, the controller 200 may control the image sensor 60 to obtain the image of the interior of the chamber 24. The image obtained by the image sensor 60 may be a thermal image. The controller 200 may process the image to obtain a contour, surface area, and surface temperature distribution of the food. The image processing may be performed using an AI model (e.g., machine learning or deep learning).

The controller 200 may determine a volume of the food based on the surface area and the surface temperature distribution of the food. Specifically, the controller 200 of the cooking apparatus 1 may determine at least one frozen region that represents a temperature lower than a reference temperature (e.g., 0° C.) from the surface temperature distribution of the food (702). As described with reference to FIG. 5, the controller 200 may divide the surface of the food into a plurality of regions according to the surface temperature distribution. The controller 200 may identify a temperature of each of the plurality of regions.

The controller 200 may determine the volume of the food to be a first volume (large volume), based on a ratio of the at least one frozen region to the surface area of the food being greater than a reference ratio (e.g., 40%) (703, 704). The controller 200 may perform a first main defrost process (large-volume defrost process) corresponding to the first volume (large volume) of the food (705).

The controller 200 may determine the volume of the food to be a second volume (small volume), which is smaller than the first volume, based on the ratio of the at least one frozen region to the surface area of the food being less than or equal to the reference ratio (e.g., 40%) (703, 706). The controller 200 may then perform a second main defrost process (small-volume defrost process) corresponding to the second volume (small volume) of the food (707).

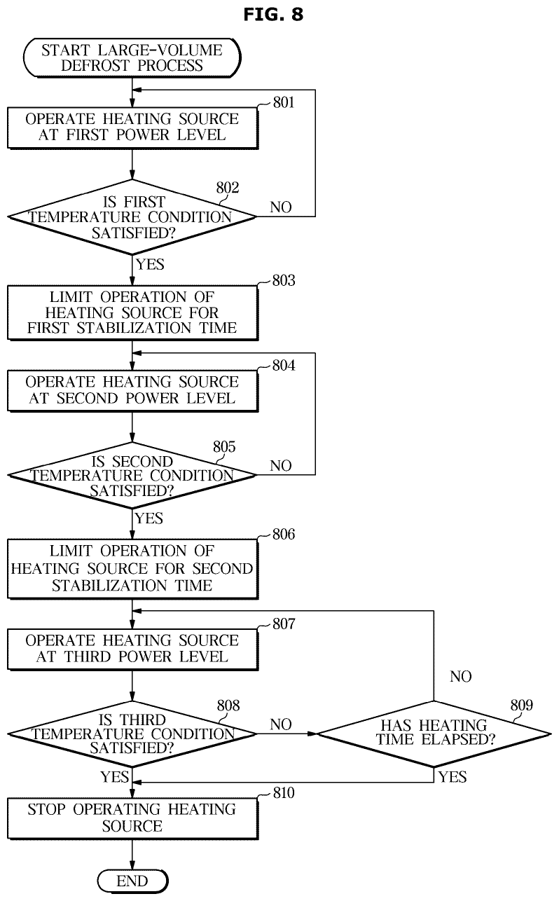

FIG. 8 is a flowchart illustrating a defrost process performed in a case where the volume of food is relatively large.

Referring to FIG. 8, a large-volume defrost process corresponds to a first main defrost process. The first main defrost process may include three heating processes and three stabilization processes. The heating process refers to operating the heating source 31 to heat the food. The stabilization process refers to limiting an operation of the heating source 31 to stabilize the temperature of the food. The heating process and the stabilization process may be performed alternately. While performing the plurality of heating processes sequentially, the controller 200 of the cooking apparatus 1 may gradually reduce a power level of the heating source 31. In addition, the controller 200 may set a different stabilization time for each of the plurality of stabilization processes.

Once the large-volume defrost process starts, the controller 200 of the cooking apparatus 1 may operate the heating source 31 at a first power level (e.g., 40%) (801). Operating the heating source 31 at the first power level corresponds to a first heating process. While performing the first heating process, the controller 200 may obtain images of the food at predetermined time intervals and detect a surface temperature distribution of the food. During the first heating process, the controller 200 may identify whether a first temperature condition is satisfied based on the surface temperature distribution of the food (802). For example, the first temperature condition may be ‘an average surface temperature of the food is greater than or equal to 10° C., and the lowest temperature in the surface temperature distribution of the food is greater than or equal to 0° C.,’ or ‘the highest temperature in the surface temperature distribution of the food is greater than or equal to 26° C., and the lowest temperature is less than or equal to −4° C.’

Based on the first temperature condition being satisfied, the controller 200 of the cooking apparatus 1 may limit the operation of the heating source 31 for a first stabilization time (e.g., 1 minute) (803). The heating source 31 may operate at 10% power level or stop operating for the first stabilization time. Limiting the operation of the heating source 31 for the first stabilization time corresponds to a first stabilization process. Molecules in the heated food may transfer heat to each other during the stabilization time. By setting a stabilization time, temperature differences in the plurality of regions of the food may be reduced, and the temperature of the food may be stabilized.

After the first stabilization time elapses, the controller 200 may operate the heating source 31 at a second power level (e.g., 30%) (804). Operating the heating source 31 at the second power level corresponds to a second heating process. While performing the second heating process, the controller 200 may obtain images of the food at predetermined time intervals and detect a surface temperature distribution of the food. During the second heating process, the controller 200 may identify whether a second temperature condition is satisfied based on the surface temperature distribution of the food (805). For example, the second temperature condition may be ‘an average surface temperature of the food is greater than or equal to 20° C., and the lowest temperature in the surface temperature distribution of the food is greater than or equal to 10° C.,’ or ‘the highest temperature in the surface temperature distribution of the food is greater than or equal to 37° C.’

Based on the second temperature condition being satisfied, the controller 200 of the cooking apparatus 1 may limit the operation of the heating source 31 for a second stabilization time (e.g., 30 seconds) (806). The heating source 31 may stop operating for the second stabilization time. Limiting the operation of the heating source 31 for the second stabilization time corresponds to a second stabilization process.

After the second stabilization time elapses, the controller 200 may operate the heating source 31 at a third power level (e.g., 10%) for a predetermined heating time (e.g., 3 minutes) (807). Operating the heating source 31 at the third power level for the heating time corresponds to a third heating process.

While performing the third heating process, the controller 200 may obtain images of the food at predetermined time intervals and detect a surface temperature distribution of the food. During the third heating process, the controller 200 may identify whether a third temperature condition is satisfied based on the surface temperature distribution of the food (808). For example, the third temperature condition may be ‘an average surface temperature of the food is greater than or equal to 24° C.,’ or ‘the highest temperature in the surface temperature distribution of the food is greater than or equal to 39° C.’

Based on the third temperature condition being satisfied before the heating time elapses, the controller 200 of the cooking apparatus 1 may stop operating the heating source 31 and end the defrost process (810).

Alternatively, based on the third temperature condition being satisfied before the heating time elapses, the controller 200 may stop operating the heating source 31 and wait for the remaining heating time, and then end the defrost process. In this case, the remaining heating time may correspond to a third stabilization time.

Based on the third temperature condition not being satisfied within the heating time (e.g., 3 minutes), the controller 200 may stop operating the heating source 31 after the heating time elapses (809, 810).

As such, the cooking apparatus 1 according to the disclosure may automatically perform the defrost process corresponding to a large volume of food and gradually adjust the power level of the heating source according to temperature changes of the food, thereby increasing defrost efficiency.

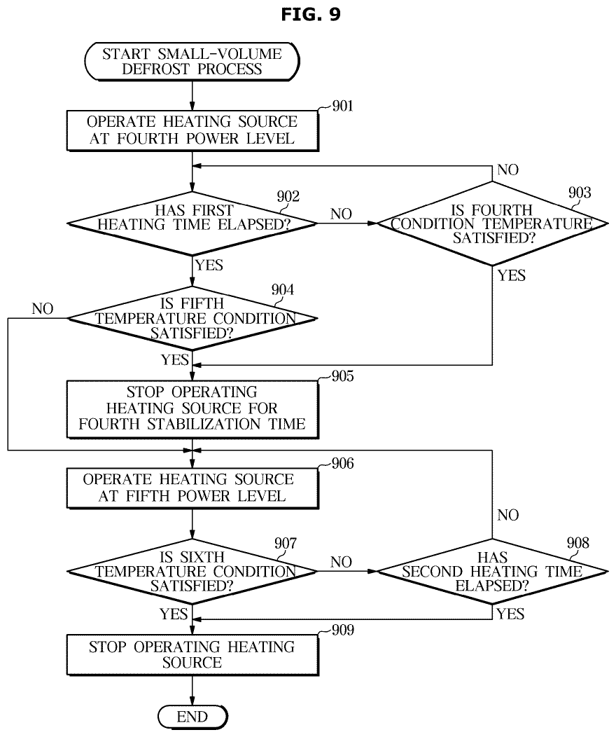

FIG. 9 is a flowchart illustrating a defrost process performed in a case where the volume of food is relatively small.

Referring to FIG. 9, a small-volume defrost process corresponds to a second main defrost process. The second main defrost process may include two heating processes and two stabilization processes. The heating process refers to operating the heating source 31 to heat the food. The stabilization process refers to limiting an operation of the heating source 31 to stabilize the temperature of the food. The heating process and the stabilization process may be performed alternately. While performing the plurality of heating processes sequentially, the controller 200 of the cooking apparatus 1 may gradually reduce a power level of the heating source 31. The controller 200 may set a different stabilization time for each of the plurality of stabilization processes. In addition, the controller 200 may set a different heating time for each of the plurality of heating processes.

Once the small-volume defrost process starts, the controller 200 of the cooking apparatus 1 may operate the heating source 31 at a fourth power level (e.g., 20%) for a predetermined first heating time (e.g., 70 seconds) (901). Operating the heating source 31 at the fourth power level corresponds to a fourth heating process. While performing the fourth heating process, the controller 200 may obtain images of the food at predetermined time intervals and detect a surface temperature distribution of the food.

During the fourth heating process, the controller 200 may identify whether a fourth temperature condition is satisfied based on the surface temperature distribution of the food (903). For example, the fourth temperature condition may be ‘the highest temperature in the surface temperature distribution of the food is greater than or equal to 35° C.’ Based on the fourth temperature condition being satisfied, the controller 200 may stop operating the heating source 31 for a fourth stabilization time (e.g., 30 seconds) (905). Stopping operation of the heating source 31 for the fourth stabilization time corresponds to a fourth stabilization process.

Based on the fourth temperature condition not being satisfied within the first heating time (e.g., 70 seconds), the controller 200 may determine whether a fifth temperature condition is satisfied after the first heating time elapses (902, 904). For example, the fifth temperature condition may be ‘an average surface temperature of the food is greater than or equal to 14° C. and the lowest temperature in the surface temperature distribution of the food is greater than or equal to 4° C.,’ or ‘the highest temperature in the surface temperature distribution of the food is greater than or equal to 28° C.’

Based on the fifth temperature condition being satisfied after the first heating time elapses, the controller 200 may stop operating the heating source 31 for the fourth stabilization time (e.g., 30 seconds) (905). In a case where the fifth temperature condition is not satisfied after the first heating time elapses, a subsequent heating process may be performed without the fourth stabilization process.

After the fourth stabilization time elapses, the controller 200 may operate the heating source 31 at a fifth power level (e.g., 10%) for a predetermined second heating time (e.g., 90 seconds) (906). Operating the heating source 31 at the fifth power level for the heating time corresponds to a fifth heating process.

While performing the fifth heating process, the controller 200 may obtain images of the food at predetermined time intervals and detect a surface temperature distribution of the food. During the fifth heating process, the controller 200 may identify whether a sixth temperature condition is satisfied based on the surface temperature distribution of the food (907). For example, the sixth temperature condition may be ‘an average surface temperature of the food is greater than or equal to 16° C.,’ or ‘the highest temperature in the surface temperature distribution of the food is greater than or equal to 30° C.’

Based on the sixth temperature condition being satisfied before the second heating time elapses, the controller 200 of the cooking apparatus 1 may stop operating the heating source 31 and end the defrost process (909).

Alternatively, based on the sixth temperature condition being satisfied before the second heating time elapses, the controller 200 may stop operating the heating source 31 and wait for the remaining second heating time, and then end the defrost process. In this case, the remaining heating time may correspond to a fifth stabilization time.

Based on the sixth temperature condition not being satisfied within the second heating time (e.g., 90 seconds), the controller 200 may stop operating the heating source 31 after the second heating time elapses, and may end the defrost process (908, 909).

As such, the cooking apparatus 1 according to the disclosure may automatically perform a defrost process corresponding to the small volume of food, and may gradually adjust a power level of the heating source according to changes in the temperature of the food, thereby increasing defrost efficiency.

The terms used in FIG. 9, such as the fourth power level, fifth power level, fourth temperature condition, fifth temperature condition, sixth temperature condition, fourth stabilization time, and fifth stabilization time, are used to distinguish from the terms used in FIG. 8. It is to be understood that FIG. 8 and FIG. 9 describe two separate defrost processes.

According to an embodiment of the disclosure, the cooking apparatus 1 may include: a chamber in which food to be heated is placeable; a heating source configured to heat the food placed in the chamber; an image sensor configured to obtain an image of the food placed in the chamber; and a controller configured to: with the food placed in the chamber, operate the heating source for a preliminary defrost time to perform a preliminary defrost of the food based on entering a defrost mode; identify a surface area of the food and a surface temperature distribution of the food from the image obtained by the image sensor after an elapse of the preliminary defrost time; determine a volume of the food based on the surface area and the surface temperature distribution of the food; and perform a main defrost process corresponding to the determined volume of the food. The controller may be configured to adjust a power level of the heating source based on the volume and a change in the identified surface temperature distribution of the food during the main defrost process.

The controller may be configured to: with the food placed in the chamber, set a preheating time to be shorter than the preliminary defrost time, and before the heating source is operated for the preliminary defrost time, operate the heating source at a maximum power level for the preheating time.

The controller may be configured to, with the food placed in the chamber, determine at least one frozen region of the food where a temperature of the food in the surface area of the food is lower than a reference temperature based on the surface temperature distribution of the food; and determine the volume of the food based on a ratio of the at least one frozen region to the surface area of the food.

The controller may be configured to, with the food placed in the chamber, determine the volume of the food as a first volume based on the ratio of the at least one frozen region to the surface area of the food being greater than a reference ratio; or determine the volume of the food as a second volume smaller than the first volume based on the ratio of the at least one frozen region to the surface area of the food being less than or equal to the reference ratio.

The main defrost process may include a plurality of heating processes for operating the heating source to heat the food, and a plurality of stabilization processes for limiting an operation of the heating source to stabilize a temperature of the food. The controller may be configured to, during the main defrost process, alternately perform a heating process of the plurality of heating processes and a stabilization process of the plurality of stabilization processes a plurality of times.

The controller may be configured to, during the main defrost process, gradually reduce the power level of the heating source while the plurality of heating processes are performed.

The controller may be configured to, during the main defrost process, set a temperature condition for each of the plurality of heating processes based on the volume of the food; identify whether the temperature condition is satisfied based on the surface temperature distribution of the food while performing each of the plurality of heating processes; and based on the temperature condition being satisfied, stop the heating process and perform the stabilization process.

The controller may be configured to, during the main defrost process, set a different temperature condition for each of the plurality of heating processes based on the volume of the food.

The controller may be configured to, during the main defrost process, set the power level to be different and the heating time to be different for each of the plurality of heating processes based on the volume of the food; and limit the operation of the heating source for a stabilization time which is set for each stabilization process of the plurality of stabilization processes after an elapse of the heating time.

The controller may be configured to perform a first main defrost process corresponding to a first volume; or perform a second main defrost process corresponding to a second volume. The controller may be configured to set the power level of the heating source to be different for the first main defrost process and the second main defrost process.

According to an embodiment of the disclosure, a cooking apparatus including a chamber in which food to be heated is placeable, a heating source configured to heat the food placed in the chamber, and an image sensor configured to obtain an image of the food placed in the chamber, the method for controlling the cooking apparatus 1 may include: with the food placed in the chamber, operating a heating source for a preliminary defrost time to perform a preliminary defrost on food placed in a chamber, based on entering a defrost mode; identifying a surface area of the food and a surface temperature distribution of the food from an image obtained by the image sensor after an elapse of the preliminary defrost time; determining a volume of the food based on the surface area and the surface temperature distribution of the food; performing a main defrost process corresponding to the volume of the food; and adjusting a power level of the heating source based on the volume and a change in the surface temperature distribution of the food during the main defrost process.

The method may further include setting a preheating time to be shorter than the preliminary defrost time; and operating the heating source at a maximum power level for the preheating time before the heating source is operated for the preliminary defrost time.

The determining of the volume of the food may include: determining at least one frozen region of the food where a temperature of the food in the surface area of the food is lower than a reference temperature based on the surface temperature distribution of the food; and determining the volume of the food based on a ratio of the at least one frozen region to the surface area of the food.

The determining of the volume of the food may include: determining the volume of the food as a first volume based on the ratio of the at least one frozen region to the surface area of the food being greater than a reference ratio; or determining the volume of the food as a second volume smaller than the first volume based on the ratio of the at least one frozen region to the surface area of the food being less than or equal to the reference ratio.

The main defrost process may include a plurality of heating processes for operating the heating source to heat the food, and a plurality of stabilization processes for limiting an operation of the heating source to stabilize a temperature of the food. The performing of the main defrost process may include alternately performing a heating process of the plurality of heating processes and a stabilization process of the plurality of stabilization processes a plurality of times.

The adjusting of the power level may include gradually reducing the power level of the heating source while performing the plurality of heating processes.

The performing of the main defrost process may include: setting a temperature condition for each of the plurality of heating processes based on the volume of the food; identifying whether the temperature condition is satisfied based on the surface temperature distribution of the food while performing each of the plurality of heating processes; and stopping the heating process based on the temperature condition being satisfied, and performing the stabilization process.

The setting of the temperature condition may include setting a different temperature condition for each of the plurality of heating processes based on the volume of the food.

The performing of the main defrost process may include: setting a different power level of the heating source and a different heating time of the food for each of the plurality of heating processes based on the volume of the food; and limiting the operation of the heating source for a stabilization time which is set for each of the plurality of stabilization processes after an elapse of the heating time.

The performing of the main defrost process may include: performing a first main defrost process corresponding to a first volume, based on the volume of the food being determined as the first volume; or performing a second main defrost process corresponding to a second volume smaller than the first volume, based on the volume of the food being determined as the second volume. The power level of the heating source may be set differently for the first main defrost process and the second main defrost process.

According to the disclosure, the cooking apparatus and the method for controlling the same may automatically identify the volume of food placed in the chamber and may perform a defrost process corresponding to the volume of the food. Accordingly, a user does not require to enter the weight or size of the food.

According to the disclosure, the cooking apparatus and the method for controlling the same may perform different defrost processes according to the volume of the food and may stepwise adjust a power level of the heating source according to changes in the temperature of the food.

According to the disclosure, the cooking apparatus and the method for controlling the same may automatically perform a defrost process corresponding to the volume of the food without a user having to enter the weight or size of the food, thereby increasing defrost efficiency. In addition, a user does not require to pause the defrost process to turn over or reposition the food, or wait for a time to pause the defrost process.

Meanwhile, the disclosed embodiments may be implemented in the form of a recording medium that stores instructions executable by a computer. The instructions may be stored in the form of program codes, and when executed by a processor, the instructions may create a program module to perform operations of the disclosed embodiments.

The machine-readable recording medium may be provided in the form of a non-transitory storage medium. Here, when a storage medium is referred to as “non-transitory,” it may be understood that the storage medium is tangible and does not include a signal (electromagnetic waves), but rather that data is semi-permanently or temporarily stored in the storage medium. For example, a “non-transitory storage medium” may include a buffer in which data is temporarily stored.

The methods according to the various embodiments disclosed herein may be provided in a computer program product. The computer program product may be traded between a seller and a buyer as a product. The computer program product may be distributed in the form of a machine-readable storage medium (e.g., compact disc read only memory (CD-ROM)), or may be distributed through an application store (e.g., Play Store™) online. In the case of online distribution, at least a portion of the computer program product may be stored at least semi-permanently or may be temporarily generated in a storage medium, such as a memory of a server of a manufacturer, a server of an application store, or a relay server.

Although embodiments of the disclosure have been described with reference to the accompanying drawings, a person having ordinary skilled in the art will appreciate that other specific modifications may be easily made without departing from the technical spirit or essential features of the disclosure. Accordingly, the foregoing embodiments should be regarded as illustrative rather than limiting in all aspects.

1. A cooking apparatus, comprising:
a chamber in which food to be heated is placeable;
a heating source configured to heat the food placed in the chamber;
an image sensor configured to obtain an image of the food placed in the chamber; and
a controller configured to:
with the food placed in the chamber,
based on entering a defrost mode, operate the heating source for a preliminary defrost time to perform a preliminary defrost of the food,
identify a surface area of the food and a surface temperature distribution of the food from the image of the food obtained by the image sensor after an elapse of the preliminary defrost time,
based on the identified surface area and the identified surface temperature distribution, determine a volume of the food,
perform a main defrost process corresponding to the determined volume, and
during the main defrost process, adjust a power level of the heating source based on the determined volume and a change in the identified surface temperature distribution.

2. The cooking apparatus of claim 1, wherein
the controller is further configured to:
with the food placed in the chamber,
set a preheating time to be shorter than the preliminary defrost time, and
before the heating source is operated for the preliminary defrost time, operate the heating source at a maximum power level for the preheating time.

3. The cooking apparatus of claim 1, wherein
the controller is further configured to:
with the food placed in the chamber,
based on the identified surface temperature distribution, determine at least one frozen region of the food where a temperature of the food in the surface area of the food is lower than a reference temperature, and
based on a ratio of the determined at least one frozen region to the identified surface area, determine the volume of the food.

4. The cooking apparatus of claim 3, wherein
the controller is further configured to:
with the food placed in the chamber,
based on the ratio of the determined at least one frozen region to the identified surface area being greater than a reference ratio, determine the volume of the food as a first volume, or
based on the ratio of the determined at least one frozen region to the identified surface area being less than or equal to the reference ratio, determine the volume of the food as a second volume smaller than the first volume.

5. The cooking apparatus of claim 1, wherein
the main defrost process includes:
a plurality of heating processes for operating the heating source to heat the food, and
a plurality of stabilization processes for limiting an operation of the heating source to stabilize a temperature of the food, and
the controller is further configured to:
during the main defrost process, alternately perform a heating process of the plurality of heating processes and a stabilization process of the plurality of stabilization processes a plurality of times.

6. The cooking apparatus of claim 5, wherein
the controller is further configured to:
during the main defrost process,
perform the plurality of heating processes, and
gradually reduce the power level of the heating source while the plurality of heating processes are performed.

7. The cooking apparatus of claim 5, wherein
the controller is further configured to:
during the main defrost process,
for each heating process of the plurality of heating processes,
set a temperature condition based on the determined volume of the food,
identify whether the set temperature condition is satisfied based on a surface temperature distribution of the food while performing the heating process, and
based on the temperature condition being identified as satisfied, stop the heating process and perform the stabilization process of the plurality of stabilization processes.

8. The cooking apparatus of claim 7, wherein
the controller is further configured to:
during the main defrost process,
set a different temperature condition for each heating process of the plurality of heating processes based on the determined volume of the food.

9. The cooking apparatus of claim 5, wherein
the controller is further configured to:
during the main defrost process,
perform the plurality of heating processes,
for each heating process of the plurality of heating processes, set the power level to be different and the heating time to be different based on the determined volume of the food, and
limit the operation of the heating source for a stabilization time which is set for each stabilization process of the plurality of stabilization processes after an elapse of the heating time.

10. The cooking apparatus of claim 4, wherein
the controller is further configured to:
with the food placed in the chamber,
perform a first main defrost process corresponding to the determined first volume, or perform a second main defrost process corresponding to the determined second volume, and
set the power level of the heating source to be different for the first main defrost process and the second main defrost process.

11. A method for controlling a cooking apparatus including a chamber in which food to be heated is placeable, a heating source configured to heat the food placed in the chamber, and an image sensor configured to obtain an image of the food placed in the chamber, the method including:
with the food placed in the chamber,
based on entering a defrost mode, operating a heating source for a preliminary defrost time to perform a preliminary defrost of the food,
identifying a surface area of the food and a surface temperature distribution of the food from an image of the food obtained by the image sensor after an elapse of the preliminary defrost time,
based on the identified surface area and the identified surface temperature distribution, determining a volume of the food,
performing a main defrost process corresponding to the determined volume, and
during the main defrost process, adjusting a power level of the heating source based on the determined volume and a change in the identified surface temperature distribution.

12. The method of claim 11, further comprising:
with the food placed in the chamber,
setting a preheating time to be shorter than the preliminary defrost time; and
before the heating source is operated for the preliminary defrost time, operating the heating source at a maximum power level for the preheating time.

13. The method of claim 11, wherein
the determining the volume includes:
based on the identified surface temperature distribution, determining at least one frozen region of the food where a temperature of the food in the surface area of the food is lower than a reference temperature, and
based on a ratio of the determined at least one frozen region to the identified surface area, determining the volume of the food.

14. The method of claim 13, wherein
the determining the volume includes:
based on the ratio of the determined at least one frozen region to the identified surface area being greater than a reference ratio, determining the volume of the food as a first volume, or
based on the ratio of the determined at least one frozen region to the identified surface area being less than or equal to the reference ratio, determining the volume of the food as a second volume smaller than the first volume.

15. The method of claim 11, wherein
the main defrost process includes:
a plurality of heating processes for operating the heating source to heat the food, and
a plurality of stabilization processes for limiting an operation of the heating source to stabilize a temperature of the food, and
the performing the main defrost process includes alternately performing a heating process of the plurality of heating processes and a stabilization process of the plurality of stabilization processes a plurality of times.
